(19) United States
(12) Patent Application Publication
(10) Pub. No.: US 2026/0259529 A1
(43) Pub. Date: Sep. 3, 2026

(54) ASSEMBLY OF A BAND PORTION ON A WATCH MIDDLE

(71) Applicant: ROLEX SA, Geneva (CH)

(72) Inventor: Martin Christian, Loisy (FR)

(73) Assignee: ROLEX SA, Geneva (CH)

(21) Appl. No.: 19/547,120

(22) Filed: Feb. 23, 2026

(30) Foreign Application Priority Data
Feb. 28, 2025 (EP) 25160885.7

(51) Int. Cl. G04B 37/14; A44C 5/14

(52) U.S. Cl. CPC G04B 37/1486; A44C 5/14

(57) ABSTRACT

The device for fastening a band portion to a watch middle includes: a connecting element (1), intended for a connection to a band portion (10) and to a watch middle (6); two distinct arbors (2), each arranged in a respective arbor housing (1a; 6a) provided within the connecting element (1) or within a watch middle (6), and capable of occupying a projecting position to fasten the connecting element (1) and the middle (6) using the two arbors (2). At least one of the two arbors (2) is movably mounted so that it can also occupy a retracted position to separate the connecting element (1) from the middle (6). The arbor housing (1a; 6a) incorporates a return element (3) acting elastically on the at least one arbor (2) to urge it in its projecting position. A stop element (4) coaxial with the at least one arbor (2) in the arbor housing (1a; 6a) and includes a stop (4c) on which the at least one arbor (2) comes to bear in its projecting position; and a central opening (4a) within which the at least one arbor (2) moves when switching between the retracted position and the projecting position.

### CROSS-REFERENCE TO RELATED APPLICATION

This application claims priority of European patent application No. EP25160885.7 filed Feb. 28, 2025, the content of which is hereby incorporated by reference herein in its entirety.

### FIELD OF THE INVENTION

The invention relates to a device for fastening a band portion to a watch middle. It also relates to a timepiece as such comprising at least one such fastening device, notably a wristwatch, in which the fastening device is arranged between a band portion and a middle of the timepiece.

### BACKGROUND ART

Various devices are used to fasten a band portion in a removable and articulated manner to a middle of a wristwatch. For example, in one common prior art solution, a watch middle has two pairs of lugs, each pair of lugs delimiting a housing for receiving a link at the end of a band portion. An arbor extending between the two lugs of a pair of lugs engages with this link of the band portion, holding it in position between these two lugs, while enabling relative articulation of the band portion and the watch casing by pivoting about said arbor.

Such fastening of a band portion to a watch casing, in particular to a middle, must ideally achieve the following objectives:
It must be reliable, more particularly to prevent untimely detachment of the band portion;
It must be robust, and notably prevent wear that would cause its functionality to deteriorate over time;
It must allow user-friendly removal and fastening of a band portion, for example to enable it to be replaced easily and rapidly;
It must have an attractive esthetic appearance, in particular being compatible with the esthetic requirements of luxury timepieces.

### SUMMARY OF THE INVENTION

Existing solutions achieve at least some of the aforementioned objectives but remain open to improvement. Thus the present invention is intended to improve this situation.

Thus, the invention generally relates to an improved solution for fastening a band portion to a watch middle, and more generally to a watch casing.

More precisely, a first objective of the invention is to provide a reliable and robust solution for fastening a band portion to a watch casing.

A second objective of the invention is to provide a user-friendly solution for fastening a band portion to a watch casing.

Preferably, a third objective of the invention is to provide an esthetic solution for fastening a band portion to a watch casing.

To this end, the invention is based on a device for fastening a band portion to a watch middle, comprising a connecting element, intended for a connection to a band portion and to a watch middle, the fastening device comprising two distinct arbors, each arranged in a respective arbor housing provided within the connecting element or within a watch middle, and capable of occupying a projecting position in which an end portion of each arbor is in a projecting position relative to its respective arbor housing, enabling it to enter a hole of the middle or a hole of the connecting element, respectively, in order to fasten the connecting element and the middle by means of the two arbors, wherein at least one of the two arbors is movably mounted within its arbor housing in such a way that it can also occupy a retracted position within its arbor housing to enable the connecting element to be separated from a watch middle, the arbor housing incorporating a return element acting elastically on the at least one arbor and urging it to remain in its projecting position, the arbor housing comprising a stop element arranged coaxially with said at least one arbor in the arbor housing adapted to be attached in and removed from the arbor housing and comprising a stop on which a shoulder of the at least one arbor comes to bear in its projecting position, the stop element comprising a central opening within which the at least one arbor moves when switching from the retracted position to its projecting position and vice versa.

The invention is more specifically defined by the claims.

### BRIEF DESCRIPTION OF THE DRAWINGS

These objectives, features and advantages of the present invention are disclosed in detail in the non-limiting description of a particular embodiment provided below with reference to the appended figures, in which:

FIG. 1 is an exploded perspective view of the device for fastening a band portion to a watch middle according to one embodiment of the invention.

FIG. 2 is an exploded sectional view of the device for fastening a band portion to a watch middle according to one embodiment of the invention.

FIG. 3 is a perspective top view of the fastening device according to the embodiment of the invention in which an arbor is in a projecting position.

FIG. 4 is a sectional view of the fastening device according to the embodiment of the invention in which said arbor is in a projecting position.

FIG. 5 is a sectional view of the fastening device according to the embodiment of the invention in which said arbor is in a retracted position.

FIG. 6 is a bottom view of the fastening device according to the embodiment of the invention in which two arbors are in a projecting position.

FIG. 7 is a perspective view of the fastening device according to the embodiment of the invention assembled with a timepiece middle.

FIG. 8 is a perspective view of the fastening device according to the embodiment of the invention disassembled from a timepiece middle.

### DETAILED DESCRIPTION OF PARTICULAR EMBODIMENTS

The invention is therefore based on a device for fastening a band portion to a watch middle 6, and more generally to a watch casing.

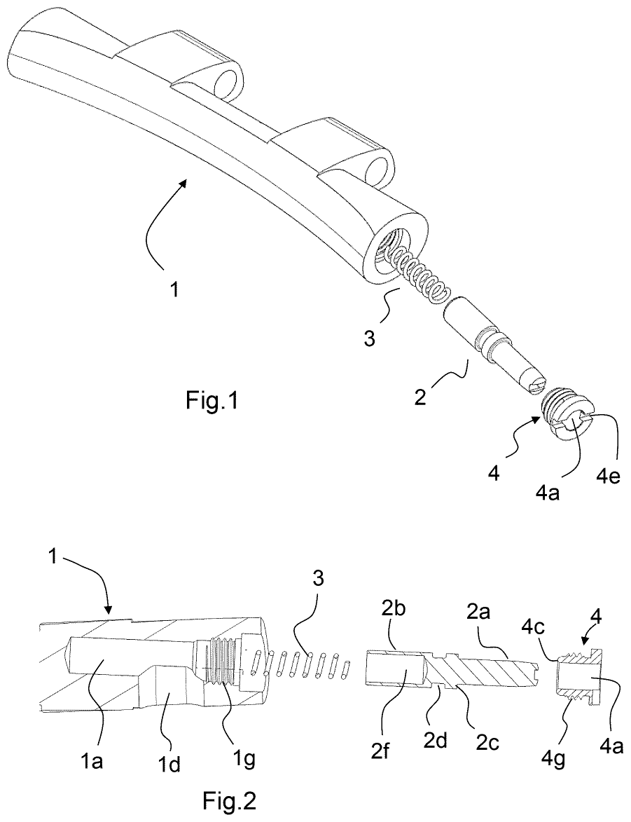

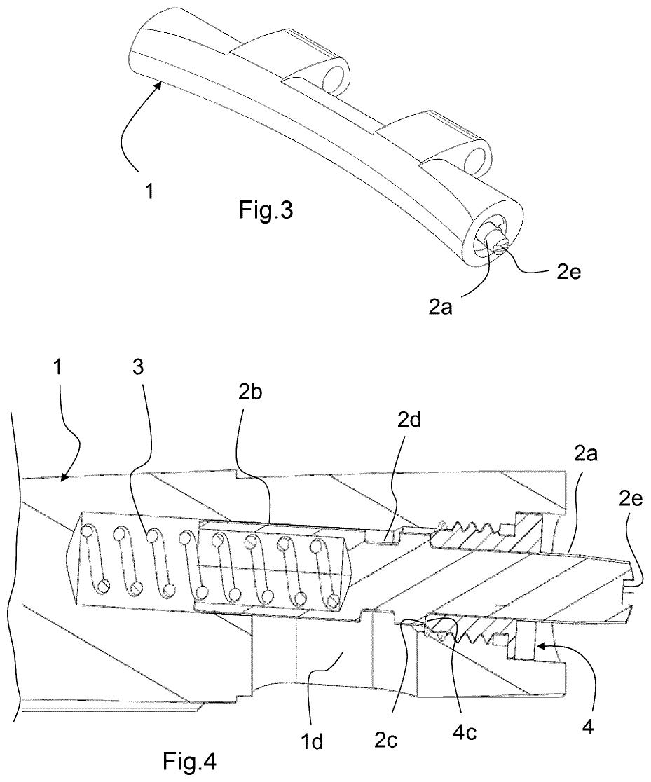

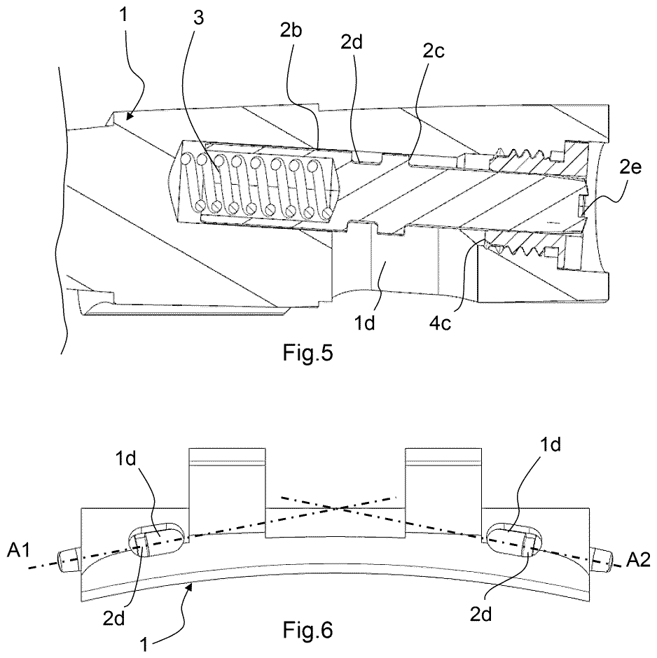

FIGS. 1 to 6 illustrate an embodiment of a fastening device, which essentially comprises a connecting element 1, two arbors 2, each associated with a return element 3 and with a stop element 4, in which the two arbors are movable. In a variant (not shown), a single arbor 2 could be movable, the second arbor 2 projecting permanently from the connecting element 1.

Furthermore, according to this embodiment, the connecting element 1 is intended to be fastened to the end of a band portion, in order to allow it to be removably fastened to a middle of a timepiece. For this purpose, the connecting element 1 preferably comprises connecting means 1b designed to be coupled to the band portion. According to the embodiment, these connecting means are in the form of two projecting links separated by an opening, to pivotingly receive an arbor arranged at the end of the band portion. The connecting element, which may comprise the shape of a link, may be considered to be an integral part of the band portion. It is visible when the watch is worn, and therefore contributes to the esthetics of the piece.

In a variant (not shown), the connecting element 1 could be mounted on the timepiece, notably the middle, so as to receive a band portion removably. In other words, the connection between a band portion and a middle can be arranged in two ways, by a fastening device intended for fastening to the end of a band portion, within a connecting element fastened to the band portion, for a removable mounting on a middle or, in a variant not shown, by a fastening device incorporated into a middle, so as to receive the removable mounting of a band portion, by means of a connecting element of the band portion.

Thus, according to the embodiment, each arbor 2 is arranged in an arbor housing 1a of the connecting element 1. This arbor housing 1a is in the form of a substantially cylindrical opening in a lateral flank of the connecting element 1, forming a bore or blind hole in the connecting element 1.

According to this embodiment, each arbor 2 extends along a longitudinal axis and comprises:
A first cylindrical portion, which extends from a first end of the arbor 2, intended to occupy a projecting position relative to its respective arbor housing 1a, so as to be able to enter respectively a hole 6a of a middle 6, to fasten the connecting element 1 and the middle 6 by means of the two arbors 2. This first cylindrical portion is referred to as the end portion 2a;
a second cylindrical portion, which preferably extends from the second end of the arbor 2, of greater diameter than the end portion 2a, this diameter corresponding substantially to the diameter of the arbor housing 1a to allow the arbor 2 to move with minimal clearance in this arbor housing 1a, as described in detail below. This second cylindrical portion is referred to as the inner portion 2b;
A shoulder 2c, formed by an annular flank of the arbor 2 at the interface between the two aforementioned cylindrical portions 2a, 2b on account of their different diameters, in the form of a surface substantially perpendicular to the longitudinal axis of the arbor 2, intended to cooperate with the stop element 4 in its projecting position,
A feature 2d, formed for example by an annular groove on the circumference of the arbor 2, allowing a watchmaker to actuate the arbor 2 with a tool, to move it from its projecting position to its retracted position, against the force exerted by the return element 3. In this embodiment, the feature 2d is positioned on the inner portion 2b.

The return element 3 is intended to act elastically on the at least one arbor 2, urging it to remain in its projecting position. It is advantageously arranged at the bottom of the housing 1a, so as to act on the second end of the arbor 2, pushing it toward the outside of the housing 1a. In this embodiment, the return element 3 is a helical spring. It comprises a first end bearing against a shoulder or on the bottom of the blind bore, and a second end bearing against the arbor 2. For this second bearing, the second end of the arbor 2 may advantageously comprise a hollow cylindrical portion 2f in which the return element 3 is positioned so as to exert said elastic return force on the arbor 2. Alternatively, any other geometry is possible, in which the arbor and the spring are nested one inside the other. In general, the arbor is preferably inscribed at least partially in the body of the spring or vice versa.

The stop element 4 is also attached and removable, toward the open end of the arbor housing 1a. It should be noted that removal advantageously allows the replacement or cleaning of the arbors during an after-sales operation. The stop element 4 comprises a tube-shaped part having a thread 4g on its outer surface to enable it to be fastened by screwing into the arbor housing 1a, the latter comprising a corresponding internal thread 1g. The stop element 4 further comprises an actuating means 4e, enabling it to be screwed or unscrewed on the connecting element 1. This actuating means 4e is for example a hollow relief, such as a groove or a notch, on its end surface, which enables it to be actuated by a tool such as a screwdriver. When it is screwed into the arbor housing, the stop element 4 is arranged coaxially with the arbor 2, and is located on the end portion 2a of the arbor 2.

The threaded tube forming the stop element 4 is also provided with a through-hole forming a longitudinal central opening 4a coaxial with the arbor 2. This central opening 4a allows the arbor 2 to pass through the stop element 4, until it reaches the projecting position. In other words, the stop element 4 comprises a central opening 4a in which the arbor 2 moves when switching from the retracted position to its projecting position, and vice versa. In the projecting position, the end portion 2a of the arbor 2 passes through the central opening 4a in the stop element 4 and the shoulder 2c of the arbor 2 abuts against an inner flank forming a stop 4c of the stop element 4. The latter thus fulfils the function of stopping the arbor 2 and delimits its displacement up to the projecting position.

Finally, the fastening device therefore comprises a connecting element 1 comprising two arbor housings 1a, two arbors 2, at least one return element 3 and at least one stop element 4. At least one of the two arbor housings 1a comprises the coaxial assembly of the return element 3, an arbor 2 and the stop element 4.

In addition, the connecting element 1 comprises a passage 1d in the form of an opening oriented substantially perpendicularly to an arbor housing 1a, preferably arranged from its lower surface, notably visible in FIG. 6. This passage 1d is positioned at the level of the feature 2d of the arbor 2 when it is positioned in the arbor housing 1a in the projecting position or in the retracted position.

The operation of the fastening device is explained below.

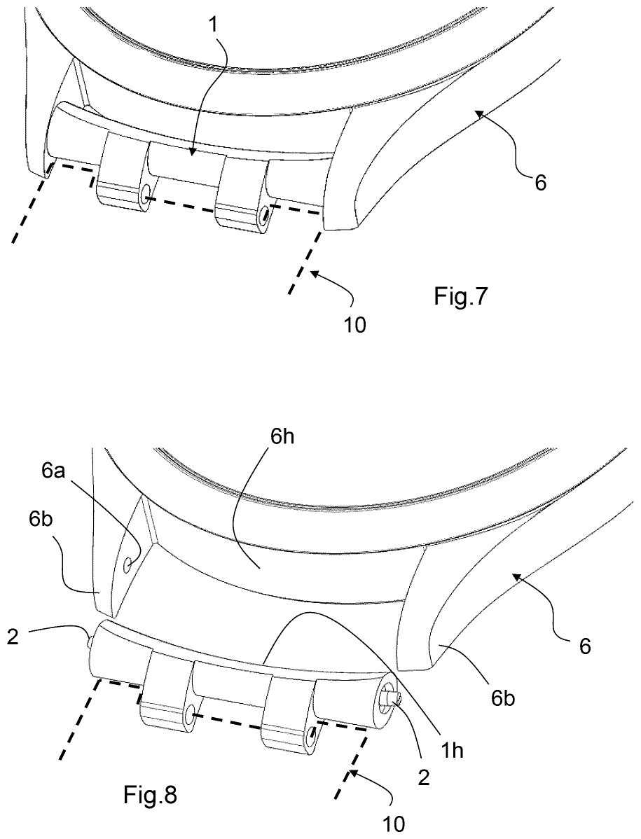

FIG. 7 shows the result obtained when the connecting element 1 is fastened to a middle 6, and more precisely between two lugs of a middle 6. To improve visibility, the band portion is not shown, but it is intended to be fastened to the connecting element 1 by means of the fastening means 1b. Thus, the connecting element 1 represents the main element of the fastening device, in between a middle and a band portion. In this fastening configuration, each arbor 2 has a position projecting from its arbor housing 1a, so that at least part of its end portion 2a is housed within an opening 6a in a lug 6b of the middle. In other words, the arbor 2 projects relative to the lateral edge of the connecting element 1, i.e. it comprises a portion situated beyond this lateral edge, outside the connecting element 1.

As shown in FIG. 7, in this fastening configuration, the connecting element 1 is arranged between two lugs 6b, i.e. in the lug width, of the middle 6. The arrangement of the fastening device, detailed above, has the advantage of a compact configuration, which makes it possible to provide a connecting element of minimal size, and of varied shape. The invention therefore provides greater freedom to define the shape and thickness of the connecting element, which allows it to adapt advantageously to the geometry 6h of the bottom of the lug width, notably to the curvature of the casing in the lug width, defined by the casing radius, and allow numerous esthetic forms. The connecting element 1 for example has a main body with a curved surface 1h adapted to match the shape 6h of the middle 6 on which it is fastened. For example, it is possible to obtain a small connecting element 1 defined by a residual wall thickness about the arbor housing 1a of the order of 0.35 mm. In addition, if the band portion is composed of several assembled links, the connecting element 1 may have or comprise a shape similar to one or more links of the band portion in order to form an assembly that appears continuous. In a variant embodiment, the band portion may be made of a flexible material, for example leather or elastomer. In this case, the connecting element can be incorporated into the end of the flexible band portion, preferably in a manner that is totally or partly concealed. As a variant, it can be an end made of metal or any other rigid material arranged at the end of the flexible band portion.

In order to disassemble the band portion from the middle 6, and to reach the configuration shown in FIG. 8, at least one arbor 2 of the fastening device has to be moved from its projecting position to its retracted position. To do this, it is possible to act manually on the feature 2d of an arbor 2 through a passage 1d of the connecting element, preferably with a tool, to actuate the arbor 2 and move it from its projecting position to its retracted position against the force exerted by the return element 3. For this purpose, the passage 1d is large enough to effect this displacement of the arbor 2. When the arbor is in the retracted position, the connecting element 1 can be separated from the lug 6b of the middle 6, enabling the connecting element 1 to be separated completely from the middle 6, and separating a band portion from the middle 6, as shown in FIG. 8. When the arbors 2 are released, they return to their projecting position under the effect of the return element 3.

It should be noted that the arbor 2 is therefore movable within the housing 1a between its two positions: the projecting position in which it is held in abutment under the effect of the return element 3, and the retracted position in which it is totally or almost totally positioned inside the arbor housing 1a. This mobility of the arbor 2 is advantageously a translation along its longitudinal axis, which coincides with the longitudinal axis of the arbor housing 1a.

Advantageously, the end of an arbor 2 intended to enter an opening 6a in a lug 6b of the middle has a frustoconical shape, which reduces the clearances and wear when the connecting element is articulated with the middle 6 using this arbor 2.

On the other hand, to best match the shape of the lug width while minimizing the size and esthetic clearance between the middle 6 and the connecting element 1, the two arbors of the fastening device are advantageously not aligned. This enables, for example, the two arbors 2 to be oriented in directions corresponding to the geometry 6h of the bottom of the lug width. Thus, the geometric axes (A1; A2) of the arbors 2 intersect and are not coaxial. In a variant, the geometric axes of the two arbors 2 can however be aligned.

The fastening device described above is advantageously adapted to any type of band portion and/or watch casing. The band portion may be made of leather, elastomer or metal. The connecting element is preferably made of metal, in particular of precious metal, such as gold or platinum, or a steel. Alternatively, the connecting element 1 may be made of technical ceramic. The same applies to the arbors 2.

Advantageously, the stop element 4 is arranged so as to be hidden by the lug 6b of the middle 6 when the fastening device is assembled with the middle 6. In this fastening configuration, the stop element 4 can be retained in the connecting element 1 by the flank of the lug 6b, which prevents any untimely disassembly of the stop element 4. Moreover, advantageously, the stop element 4 is not flush with the surface of the connecting element 1, but is slightly set back inside the arbor housing 1a so as to prevent contact with the flank of the lug 6b. This prevents any deterioration of the stop element 4, such as could occur by contact or friction with the lug 6b.

Preferably, the constituent elements of the fastening device, housed within the connecting element, are advantageously hidden when the band portion is assembled. Only the feature 2d of an arbor 2 is visible through a passage 1d. In order to reduce the impact of this visibility, particularly the esthetic impact, while avoiding a risk of untimely actuation, the passage 1d is advantageously positioned on the lower face of the connecting element, i.e. the face intended to face the wearer's wrist.

Alternatively to the embodiment disclosed, the connecting device 1 may comprise a single movable arbor 2, that can notably be moved in translation as explained above, and another arbor 2 which is not movable. In a variant, the two arbors 2 are arranged in the same manner and have the same mobility, aligned or otherwise.

In addition, each arbor 2 can rotate about its longitudinal axis or be fixed in rotation. The connecting element 1 and/or the middle 6 is advantageously movable in rotation about the arbors 2 in the fastening configuration.

As mentioned above, the connection between the fastening element and the middle could be reversed. In this alternative embodiment, the fastening elements of the fastening device are then arranged in a middle 6, for example in a lug 6b of a middle 6. In other words, the arbor housing 6a of the lug 6b can receive a return element 3, an arbor 2 and a stop element 4, in an arrangement almost identical to that described with reference to the arbor housing 1a of the connecting element 1. The latter then comprises holes 1a intended to receive the arbors 2 when the latter are arranged to project from a lug 6b. The lug comprises a passage for accessing a feature 2d of the screw 2.

The invention also relates to a timepiece, notably a wristwatch, comprising at least one fastening device as described above for removably fastening at least one end of a band portion to a middle 6 of the timepiece using the connecting element 1. Such a fastening device is advantageously arranged on each side of the watch casing, in particular of the middle, to removably fasten each band portion.

The invention also relates to a method of assembling a device for fastening a band portion to a watch middle, which comprises the following steps:
Inserting a return element 3 in the bottom of an arbor housing 1a of a connecting element 1,
Inserting an arbor 2 into the arbor housing 1a, ensuring that the end portion 2a is positioned toward the outside of the arbor housing 1a,
Positioning the stop element 4 on the open edge of the arbor housing 1a, ensuring that the arbor 2 correctly passes through the central opening 4a in the stop element 4,
Screwing the stop element 4 using a tool acting on the actuating means 4e of the stop element 4.

It should be noted that, to carry out this last step, it is advantageous for the arbor 2 to comprise a specific shape 2e, such as a groove or a notch, complementary to the shape of the actuating means 4e of the stop element 4, so as to allow said at least one arbor 2 and the stop element 4 to be actuated simultaneously using the same tool, first cooperating with the specific shape 2e of the arbor 2, then simultaneously with the actuating means 4e of the stop element 4. This makes it possible, when screwing or unscrewing the stop element 4, to prevent the watchmaker's tool, which also bears against the arbor 2 in the first place, from slipping.

In this method, the elements are advantageously inserted from the same open end of the arbor housing 1a, which is advantageously blind. More precisely, the return element 3, the arbor 2 and the stop element 4 are advantageously assembled coaxially and successively from the same open end of the arbor housing 1a.

According to a variant embodiment (not shown), the two arbors 2 could be physically in the form of a single continuous piece, sufficiently long so that its two ends can project from the connecting element 1 in a fastening configuration. This arbor can be actuated by a tool, against a return element, as described above, to retract one of the two ends. The second end then enters deeper into its corresponding opening 6a, which could be deeper or even open.

1. A device for fastening a band portion to a watch middle, comprising
a connecting element, intended for a connection to a band portion and to a watch middle, and
two distinct arbors, each arranged in a respective arbor housing provided within the connecting element or within the watch middle, and capable of occupying a projecting position in which an end portion of each respective one of the arbors is in a projecting position relative to the respective arbor housing, enabling the respective arbor to enter a hole of the watch middle or a hole of the connecting element, respectively, in order to fasten the connecting element and the watch middle using the two arbors,
wherein at least one of the two arbors is movably mounted within the respective arbor housing so as to be able to also occupy a retracted position within the respective arbor housing to enable the connecting element to be separated from a watch middle,
wherein the arbor housing incorporates a return element acting elastically on the at least one arbor and urging the at least one arbor to remain in the projecting position,
the arbor housing comprising a stop element arranged coaxially with the at least one arbor in the arbor housing and adapted to be attached in and removed from the arbor housing, the stop element being attached in the arbor housing coaxially with the at least one arbor, and comprising a stop on which a shoulder of the at least one arbor comes to bear in the projecting position, the stop element comprising a central opening within which the at least one arbor moves when switching between the retracted position to the projecting position, and an actuating feature at an end of the stop element, the actuating feature being oriented toward an outside of the arbor housing to allow the actuating feature to be mounted and removed using a tool, and the at least one arbor comprising a specific shape complementary to a shape of the actuating feature of the stop element so as to enable the at least one arbor and the stop element to be actuated simultaneously using the same tool.

2. The device as claimed in claim 1, wherein each of the two arbors is movable in the respective arbor housing so that each of the two arbors can both occupy a respective projecting position or a respective retracted position.

3. The device as claimed in claim 1, wherein the two arbors are coaxial and aligned.

4. The device as claimed in claim 1, wherein the two arbors are non-coaxial and non-aligned.

5. The device as claimed in claim 1, wherein the end portion of each of the arbors has a conical or frustoconical shape.

6. The device as claimed in claim 1, wherein the arbor housing is a blind hole coaxially incorporating, in sequence:
the return element, which is a helical spring, in a bottom of the blind hole,
the at least one arbor on an inner portion of which the return element exerts a force and
the stop element, on which the at least one arbor bears in the projecting position.

7. The device as claimed in claim 1, wherein an inner portion of the at least one arbor has a hollow portion in which at least part of the return element is positioned.

8. The device as claimed in claim 1, wherein the arbor housing comprises a passage enabling a tool to be used to act on a feature of the at least one arbor to move the at least one arbor from the projecting position to the retracted position against the force exerted by the return element.

9. The device as claimed in claim 1, wherein the stop element is set back in the arbor housing to prevent contact with a flank of a lug of the watch middle or the connecting element, respectively.

10. The device as claimed in claim 1, wherein the connecting element comprises at least one connecting means for fastening a band portion.

11. The device as claimed in claim 1, wherein the at least one arbor is movable in translation within the arbor housing, and also movable in rotation.

12. The device as claimed in claim 1, wherein the connecting element and/or the arbors is/are made of metal or of a metal alloy or of technical ceramic.

13. A wristwatch, timepiece comprising the device as claimed in claim 1.

14. The device as claimed in claim 1, wherein the connecting element has a main body configured to extend between two lugs of the watch middle, the main body having a curved surface adapted to match the shape of the watch middle on which the connecting element is intended to be fastened, in an angularly movable manner.

15. The device as claimed in claim 8, wherein the feature of the at least one arbor is a groove and the passage is an opening perpendicular or substantially perpendicular to a longitudinal axis of the arbor housing.

16. The device as claimed in claim 2, wherein the two arbors are coaxial and aligned.

17. The device as claimed in claim 2, wherein the two arbors are non-coaxial and non-aligned.

18. The device as claimed in claim 2, wherein the end portion of each of the arbors has a conical or frustoconical shape.

19. The device as claimed in claim 2, wherein the arbor housing is a blind hole coaxially incorporating, in sequence:
the return element, which is a helical spring, in a bottom of the blind hole,
the at least one arbor on an inner portion of which the return element exerts a force, and
the stop element, on which the at least one arbor bears in the projecting position.

20. The device as claimed in claim 2, wherein an inner portion of the at least one arbor has a hollow portion in which at least part of the return element is positioned.
